(19) United States
(12) Patent Application Publication
(10) Pub. No.: US 2006/0074804 A1
(43) Pub. Date: Apr. 6, 2006

(54) Systems, methods, and computer readable media for managing interest-bearing financial accounts

(75) Inventor: Sezin Cinar, Arlington, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Capital One Financial Corporation

(21) Appl. No.: 10/952,755

(22) Filed: Sep. 30, 2004

(51) Int. Cl. G06Q 40/00

(52) U.S. Cl. 705/42

(57) ABSTRACT

Methods for managing a financial account is provided. A plurality of tiers are created within the financial account, the plurality of tiers including at least a first tier and a second tier. Funds held in the second tier are subjected to more favorable terms than funds held in the first tier. Using a computer, the an amount of funds that have remained in the first tier for a first tenure period is determined. The tenured funds are graduated from the first tier to the second tier. A request to withdraw funds from the account is received. Using a computer, funds are withdrawn from the first tier before funds are withdrawn from the second tier.

### TECHNICAL FIELD

The present invention relates generally to financial products and, more particularly, to the provision and management of interest-bearing financial accounts.

### BACKGROUND

In today's marketplace, a wide range of financial products are available to customers for the purposes of generating income or investing. For example, financial products such as savings accounts, money market accounts, bonds and certificates of deposit (CDs), offer interest income to customers. In exchange, the financial institutions offering these accounts obtain the use of the customers' funds while they remain deposited. The financial institutions then reinvests these funds, e.g., by loaning the funds to other customers at higher interest rates, and thus make a profit.

Some of these financial products, such as conventional savings accounts, are demand-deposit accounts from which the customer may withdraw their funds on demand. Others of these products, such as CDs, are time-deposit accounts in which the customer agrees to leave their funds for a set period.

Time-deposit accounts are attractive to financial institutions because they offer more certainty with respect to the length of time that they may make use of the funds. Consequently, financial institutions generally offer higher interest rates on time-deposit accounts than on demand deposit accounts. Typically, the greater the amount of funds deposited into the account and the longer the customer agrees to leave their funds in the account, the higher the interest rate. For example, a $5,000 CD generally pays a higher rate than a $1,000 CD having the same duration, and a CD that matures in five years generally pays a higher interest rate than a CD of equal value that matures in one year.

The interest rate on these conventional financial products may be fixed at the opening of the account. Alternatively, the interest rate may vary over the life of the account. For example, the interest rate may be based on a market indicator, such as the Treasury rate, that varies over time.

In either case, once the customer has invested their funds, the interest rate is outside of the customer's control. Moreover, customers are generally uncertain about the future direction of the market and are often uncertain of their own future needs. Consequently, customers may hesitate to invest in time-deposit accounts because they believe that interest rates may rise beyond the rates offered for the account, and may not wish to be required to leave their funds in an account yielding a sub-optimal return. Further, customers may believe that they may need to use their funds for another purpose before maturity.

The customer may be allowed to withdraw funds from a time-deposit account, e.g., by checks drafted on the account. However, in most cases, the customer's ability to withdraw funds may be limited in scope or subject to certain penalties or fees. For example, a customer who wishes to withdraw their funds from a CD prior to maturity must generally pay a substantial penalty for the early withdrawal. Usually, the penalty is the interest earned over some period, e.g., the interest earned over the last six months. Such an out-of-pocket penalty is a substantial disincentive for customers to invest in time-deposit accounts.

Consequently, customers leave more of their savings in demand-deposit accounts yielding lower interest rates; and financial institutions have less certainty with respect to the period they may make use of funds deposited in their accounts. Accordingly, there is a need for financial products that provide greater incentives for customers to invest for longer periods, without subjecting them to an out of pocket penalty for withdrawing their funds before a set time.

### SUMMARY OF THE INVENTION

Systems, methods, and computer-readable media consistent with the present invention address these and other needs by providing mechanisms to manage financial accounts.

Consistent with the present invention, a method for managing a financial account is provided. A plurality of tiers are created within the financial account, the plurality of tiers including at least a first tier and a second tier. Funds held in the second tier are subjected to more favorable terms than funds held in the first tier. Using a computer, the an amount of funds that have remained in the first tier for a first tenure period is determined. The tenured funds are graduated from the first tier to the second tier.

Consistent with the present invention, a method for managing a financial account is provided. A plurality of tiers are created within the financial account, the plurality of tiers including at least a first tier and a second tier. Funds held in the second tier are subjected to more favorable terms than funds held in the first tier. A request to withdraw funds from the account is received. Using a computer, funds are withdrawn from the first tier before funds are withdrawn from the second tier.

It is to be understood that both the foregoing general summary and the following detailed description are exemplary and explanatory only and are not restrictive of the invention, as claimed. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a schematic illustration of an exemplary system environment, consistent with the present invention;

FIG. 2 is a flow chart that illustrates exemplary methods for providing and managing financial accounts, consistent with the present invention;

FIG. 3A is a flowchart that illustrates an exemplary deposit cycle, consistent with the present invention;

FIG. 3B is a flowchart that illustrates an exemplary graduation cycle, consistent with the present invention;

FIG. 3C is a flowchart that illustrates an exemplary interest cycle, consistent with the present invention;

FIG. 3D is a flowchart that illustrates an exemplary withdrawal cycle, consistent with the present invention;

FIG. 3E is a flowchart that illustrates an exemplary statement cycle, consistent with the present invention;

FIG. 4 is a graph that depicts a sample balance history for a tenure account, consistent with the present invention;

FIG. 5 is a table that depicts sample tier records for the sample account history of FIG. 4;

FIG. 6 is a table that depicts a sample transaction record for the sample account history of FIG. 4; and

FIG. 7 is an exemplary statement for a tenure account consistent with the present invention.

### DESCRIPTION OF THE EMBODIMENTS

Reference will now be made in detail to exemplary embodiments of the invention, examples of which are illustrated in the accompanying drawings. Wherever possible, the same reference numbers will be used throughout the drawings to refer to the same or like parts.

Financial accounts consistent with the present invention may be constructed as tiered accounts. The tiers of the account may be subject to different terms. Over time, funds deposited into one tier of the account graduate to another tier bearing more favorable terms, that is, terms providing more benefit to the owner of the funds, such as a higher interest rate. For example, each deposit to the account may start in a first tier earning a first (base) interest rate. Money left in the account for a set period (e.g., one year) may then graduate to a second tier earning an interest rate that is a higher than the first interest rate by a predetermined formula (e.g., 10% higher than the base rate). Money left in the account for subsequent periods (e.g., two years, three years) may be placed in successively higher tiers earning successively higher interest rates.

Thus, the longer the money is left in the account, the more interest it earns. In this manner, systems and methods consistent with the present invention give customers a degree of control with respect to the interest rate on the account. Systems and methods consistent with the present invention thus constitute tenure accounts and encourage customers to leave more money in the account for longer periods.

When the customer makes a withdrawal from the account, the money that was deposited last may be taken out first (“last in-first out”). In other words, the money that is subject to the terms that are least favorable for the customer (e.g., the money earning the lowest interest rate) may be taken out first; the money that is subject to the terms that are most favorable to the customer (e.g., the money earning the highest interest rate) may be taken out last. Accordingly, the money earning the highest interest rates may be left in the account longest, thus maximizing the customer's interest income.

Although the customer is penalized for making a withdrawal in the sense that their funds lose tenure, and thus earn a lower interest rate for a longer period, the customer is not subjected to an out of pocket penalty (e.g., of interest already earned, as in a conventional CD). By removing the substantial penalty for early withdrawal common to prior art accounts, systems and methods consistent with the present invention thus encourage customers to invest more funds for longer periods.

Examples 1 and 2 below set forth exemplary rules for tenure accounts consistent with the present invention.

### EXAMPLE 1

1. Five tiers are provided. The tiers may be identified as Tiers I-IV, and an Interest Tier.

2. The interest rates for Tier I and the Interest Tier are equal to the financial institution's Money Market Account Base Rate; the interest rate for Tier II is 10% higher than that of Tier I; the interest rate for Tier IlI is 15% higher than that of Tier I; and the interest rate for Tier IV is 25% higher than that of Tier I. Thus, the interest for each succeeding tier is greater than the interest rate for the previous tier by a predetermined percentage. In this manner, tenure accounts consistent with the present invention encourage customers to allow their funds to remain in the tenure account for longer periods in order to secure higher interest rates as the funds graduate to higher tiers.

3. Funds deposited by the customer are initially placed in Tier I. On the last day of each month, the funds that have remained in Tiers I, II or III for a tenure period of one year are graduated to the next higher tier, and thus earn a higher interest rate. The minimum monthly balance for each tier is considered to have remained in the tier for that month, i.e., funds that are withdrawn from Tier I and then re-deposited in the same month are not considered to have remained in that tier. Funds that remain deposited for three or more years remain in Tier IV unless withdrawn.

4. Interest from each of Tiers I-IV is distributed to the Interest Tier on a monthly basis. Funds in the interest tier may not graduate to another tier.

5. Withdrawals are effected by withdrawing funds first from the Interest Tier, and then from Tiers I, II, III and IV, in that order. In other words, funds are withdrawn from tiers having terms that are less advantageous to the customer before being withdrawn from tiers having terms that are more advantageous to the customer. For instance, the Interest Tier is considered to have terms that are less advantageous to the customer than Tier I because, although they bear the same interest rate, funds in the Interest Tier are not eligible to graduate to any other tier, while funds in Tier I are eligible to graduate to Tier II after achieving tenure.

### EXAMPLE 2

1. Four tiers are provided. The tiers may be identified as Tiers I-IV.

2. The interest rate for Tier I is equal to the financial institution's Money Market Account Base Rate; the interest rate for Tier II is 0.10 percentage points higher than that of Tier I; the interest rate for Tier III is 0.20 points higher than that of Tier I; and the interest rate for Tier IV is 0.40 points higher than that of Tier I. Thus, the interest for each succeeding tier is greater than the interest rate for the previous tier by a predetermined value.

3. Funds deposited by the customer are initially placed in Tier I. On the last day of each month, the funds that have remained in Tiers I, II or III for a tenure period of one year are graduated to the next higher tier. The closing monthly balance for each tier is considered to have remained in the tier for that month, i.e., funds that are withdrawn from Tier I and then re-deposited in the same month are considered to have remained in that tier. Funds that have graduated to Tier IV remain in that tier unless withdrawn.

4. Interest from each of Tiers I-IV is distributed back into the same tier on a monthly basis. The interest is then eligible to graduate to the next higher tier in the same manner as funds deposited by the customer.

5. Withdrawals are effected by withdrawing funds from Tiers I, II, III and IV, in that order. Thus, funds are withdrawn from tiers bearing a lower interest rate before being withdrawn from tiers having a higher interest rate.

It is to be understood that the rules embodied in Examples 1 and 2 are exemplary only, and that the terms of the tenure account may be varied, consistent with the present invention. For example, the number of tiers, the tier into which the deposit is initially placed, the conditions for the graduation of funds from one tier to another (e.g., the destination tier for funds graduating from a certain source tier, the tenure period, etc.), the interest rates or formulas, the compounding period, the method by which the interest is distributed, the method by which withdrawals are effected, etc., may be varied, consistent with the present invention. Moreover, other rules and conditions may be imposed on the account without departing from the scope of the present invention. Further variations of these rules are discussed below.

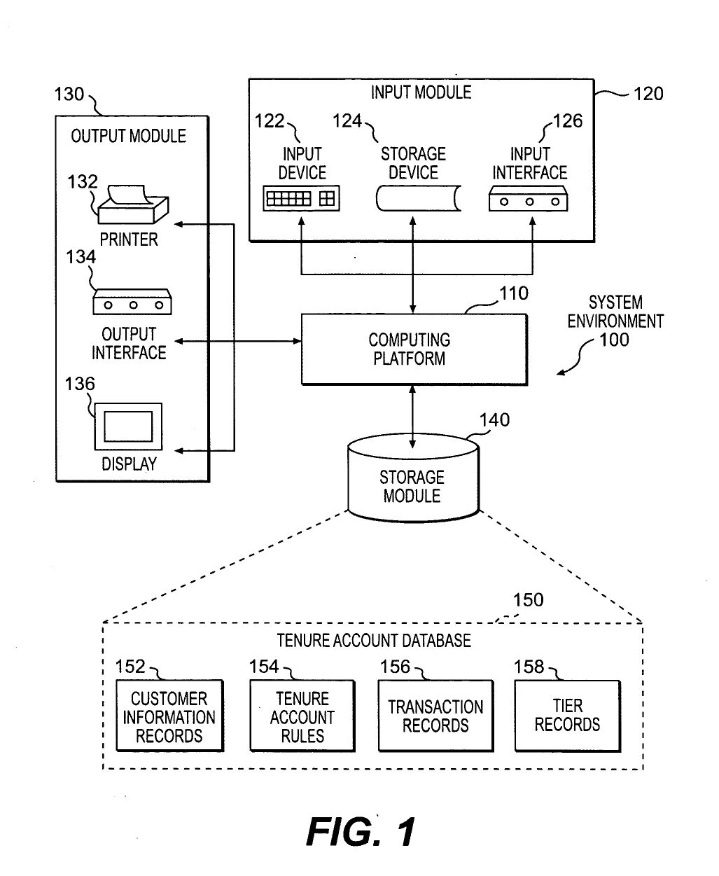

FIG. 1 illustrates an exemplary system environment 100 consistent with the present invention. As illustrated in FIG. 1, system 100 may include a computing platform 110, an input module 120, an output module 130, and a storage module 140.

Computing platform 110 may be adapted to process input information received from input module 120. Computing platform 110 may be further adapted to provide output information to output module 130. Additionally, computing platform 110 may be adapted to access data stored in storage module 140 for use in performing methods consistent with the present invention.

Computing platform 110 may comprise a general purpose computer (e.g., a personal computer, network computer, server, mainframe computer, etc.) having a processor that may be selectively activated or configured by a computer program to perform one or more methods consistent with the present invention. Alternatively, computing platform 110 may be specially constructed for carrying-out methods consistent with the present invention. Computing platform 110 may be implemented on a single platform, such as a stand-alone computer. Alternatively, computing platform 110 may be implemented on a distributed network, such as a network of computers connected, e.g., by a LAN, WAN, etc., or the Internet.

Input module 120 may include an input device 122, a storage device 124, and/or an input interface 126. Input device 122 may be implemented using any user interface adapted for data entry. For example, input device 122 may be implemented using a keyboard, mouse, speech recognition device, etc. Storage device 124 may include a computer readable medium or media that contains instructions to configure computing platform 110 to perform one or more methods consistent with the present invention.

A computer readable medium may be any type of media (e.g., RAM, ROM, etc.) that is capable of carrying information that may be used to configure computing platform 110 to perform methods consistent with the present invention. For example, computer readable media may be implemented using physical media (e.g., a punch card), magnetic media (e.g., a magnetic disk or tape), optical media (e.g., an optical disk), a carrier wave (e.g., from a computer network, such as the Internet), etc.

Storage device 124 may be implemented within storage module 140, or separately. Computing platform 110 may link storage device 124 to input interface 126. Input interface may in turn be linked to a device (not shown), such as a supplemental storage device or the Internet, for transferring instructions from a computer readable medium or media (not shown) to the storage device 124 for later execution by computing platform 110.

In creating a new tenure account, input module 120 may be used to enter or obtain information about a customer and/or, attributes of the customer's accounts. This information may be obtained, for example, from the customer, from storage device 124, from storage module 140, or from a computer readable medium or media linked to input interface 126. After a new tenure account has been created, input module 120 may be used to enter or obtain information about transactions made by the customer using the account. Computing platform 110 may store the information received from input module 120 in storage module 140.

Output module 130 may include a printer 132, an output interface 134, and/or a display 136. Printer 132 may be used, for example, to provide an account statement to the customer. Output interface 134 may be used to provide account information to the customer via a computer network, e.g., an Automated Teller Machine (ATM) network or the Internet, or to save such information on a computer readable medium or media (not shown). Output interface 134 and input interface 126 may together be implemented using a modem. Display 136 may provide account information to a customer service representative of the financial institution who may assist the customer, e.g., via telephone.

Storage module 140 may be implemented as any appropriate type of computer readable medium or media. Storage module 140 may be used to store information concerning the tenure account in a tenure account database 150. Tenure account database 150 in turn may include customer information records 152, tenure account rules 154, transaction records 156 and/or tier records 158. Tenure account database 150 may be implemented using a single database or multiple databases stored on one or more computer readable media within storage module 140.

Customer information records 152 may include the customer's identifying information, such as the customer's name, billing address, telephone number, and/or Social Security number, etc. Customer information records 152 may also include other information about the customer, such as the customer's credit rating, credit history, and/or demographic information.

Tenure account rules 154 may contain information corresponding to an account agreement between the customer and the financial institution that governs the terms of the tenure account. For example, tenure account rules may contain rules for the graduation of funds from one tier to the next, rules for the distribution of interest from each tier, etc. (e.g., as in Examples 1 or 2).

Transaction records 156 may contain information concerning transactions involving the tenure account. For example, transaction records 156 may include information concerning deposits to the account, withdrawals from the account, and/or interest earned on the account.

Tier records 158 may contain information concerning the distribution of funds among the tiers of the tenure account. For example, tier records 158 may contain information concerning the current balance of funds within each tier, the minimum balance for each tier over the respective tenure period, etc.

As described below, computing platform 110 may use the information in tenure account database 150 to manage the tenure account using methods consistent with the present invention. Computing platform 110 may also provide account information generated by computing platform 110 or obtained from input module 120 or storage module 140 to output module 130. Output module 130 in turn may output the received information to the customer, or to customer service representatives for use internally or for assisting the customer.

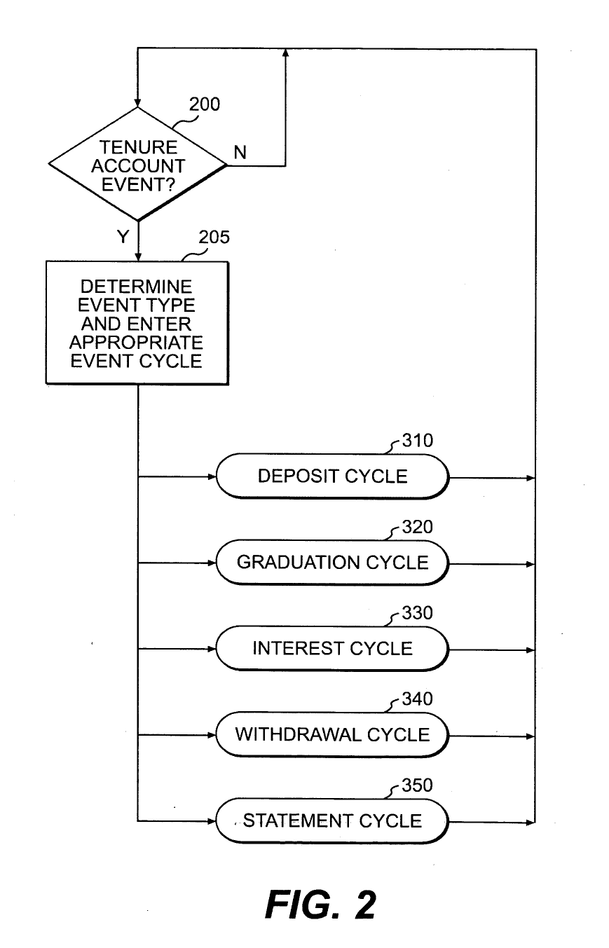

FIG. 2 is a flow chart that illustrates exemplary methods for providing and managing financial accounts, consistent with the present invention. While exemplary methods of the present invention are described as a series of acts, the order of the acts may vary in other implementations consistent with the present invention. In particular, non-dependent acts may be performed in any order, or in parallel.

At 200, system 100 may wait for the occurrence of a tenure account event. A tenure account event may be of a number of different types, e.g., a deposit cycle 310, a graduation cycle 320, an interest cycle 330, a withdrawal cycle 340, or a statement cycle 350.

At 205, system 100 may determine the type of tenure account event and enter the appropriate event cycle 310-350. For example, system 100 may receive an indication of the type of event, e.g., a deposit or withdrawal, via input module 120. Alternatively, system 100 may itself initiate certain events. For example, system 100 may programmed to enter a graduation cycle 320, interest cycle 330 and/or statement cycle 350 periodically.

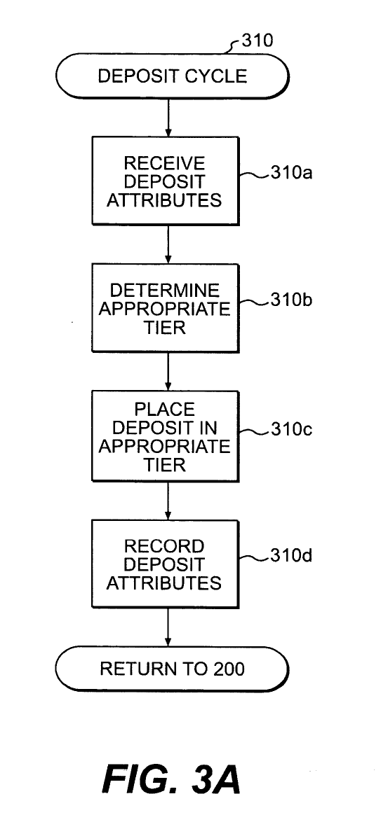

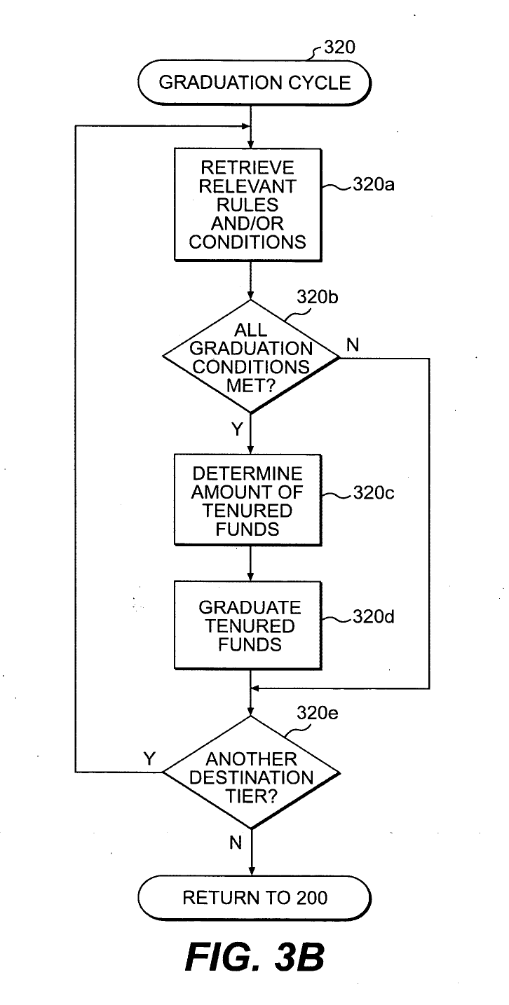

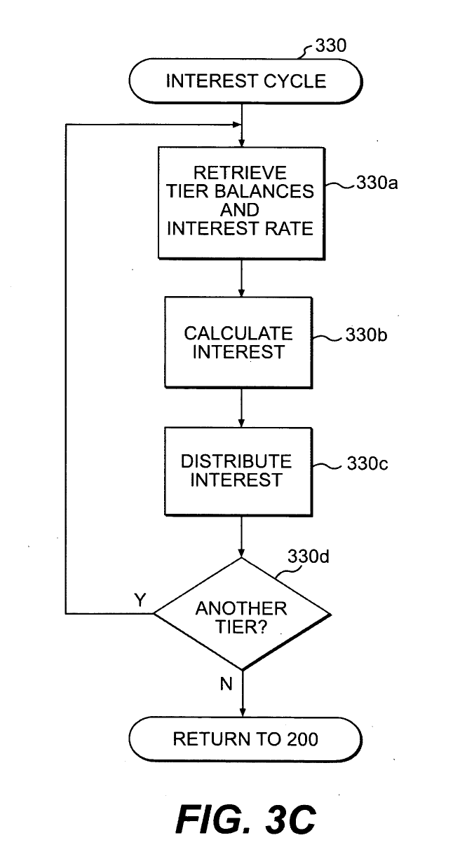

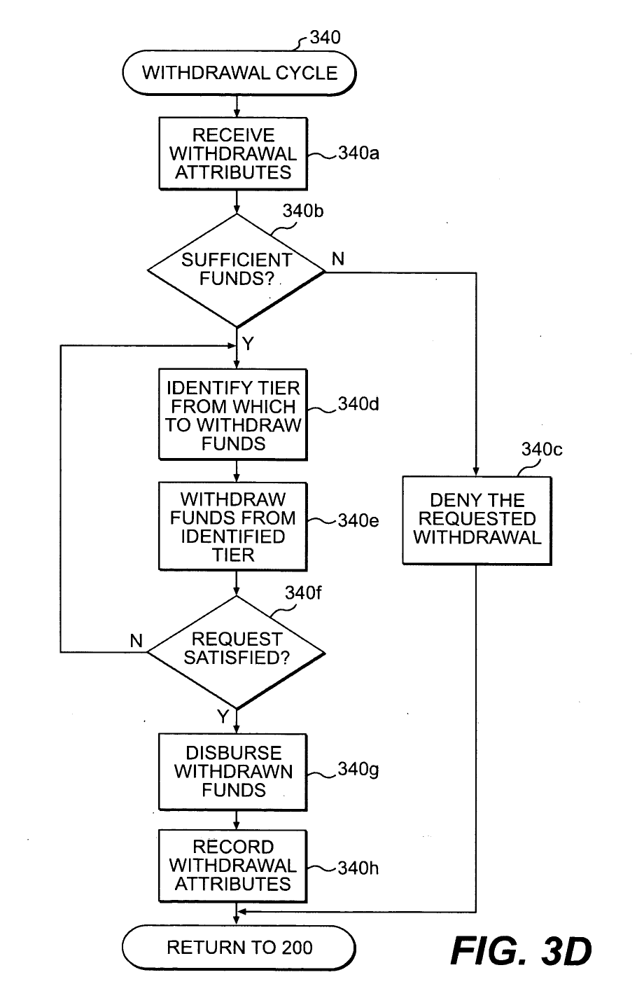

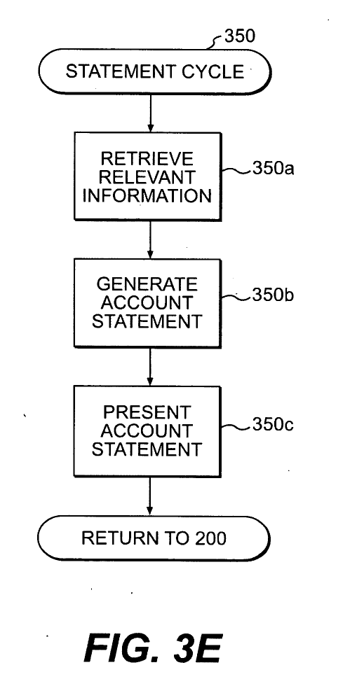

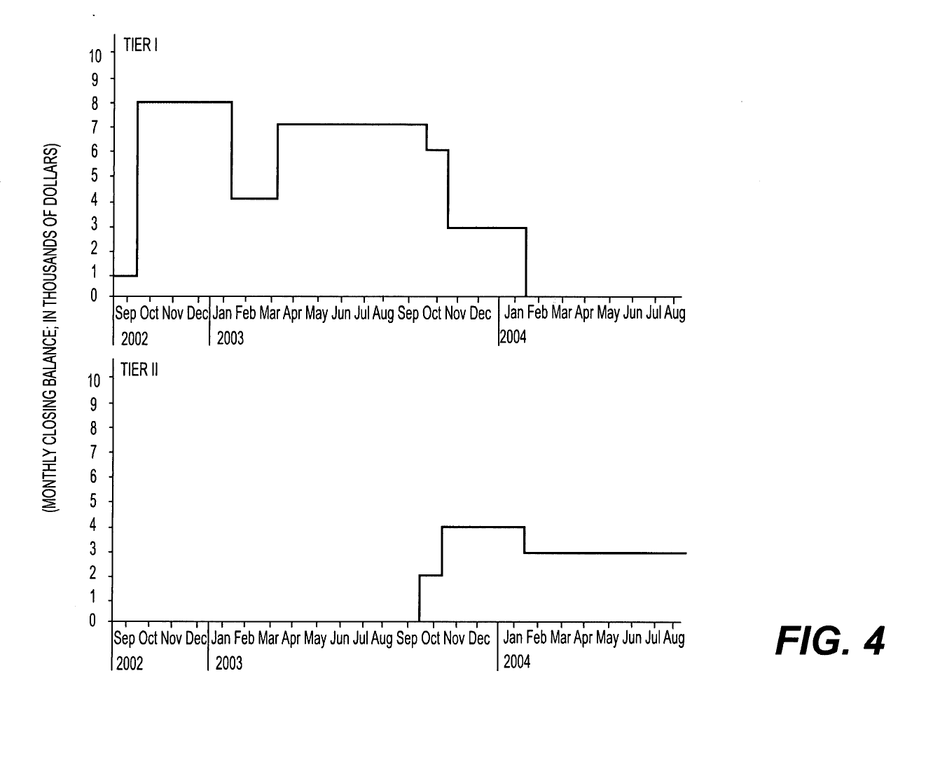

FIGS. 3A-3E are flowcharts that illustrate exemplary methods for performing event cycles 310-350, respectively. These methods are illustrated with reference to FIGS. 4-6.

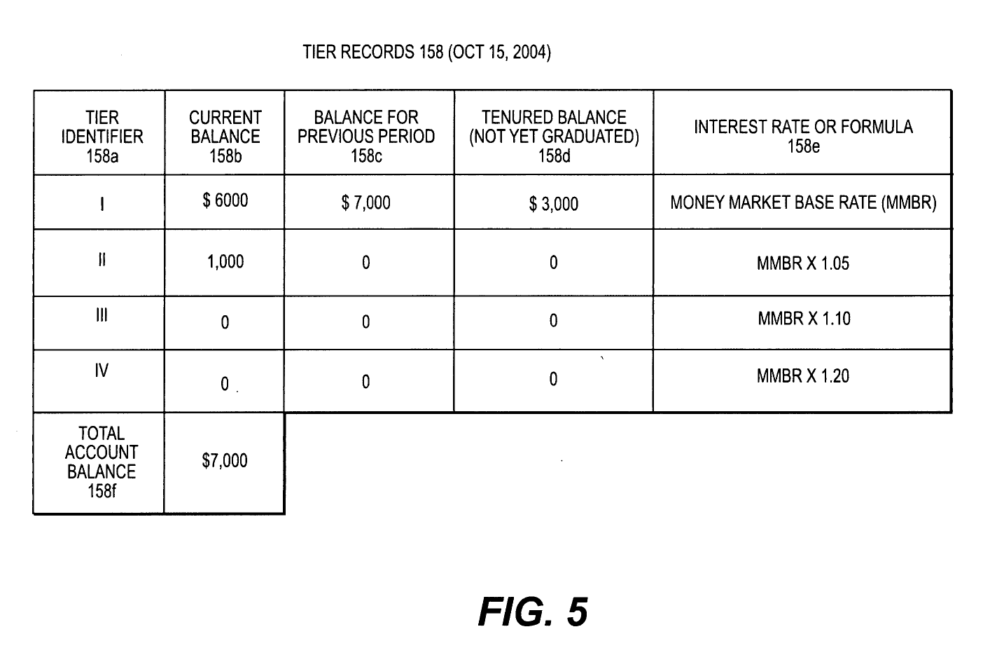

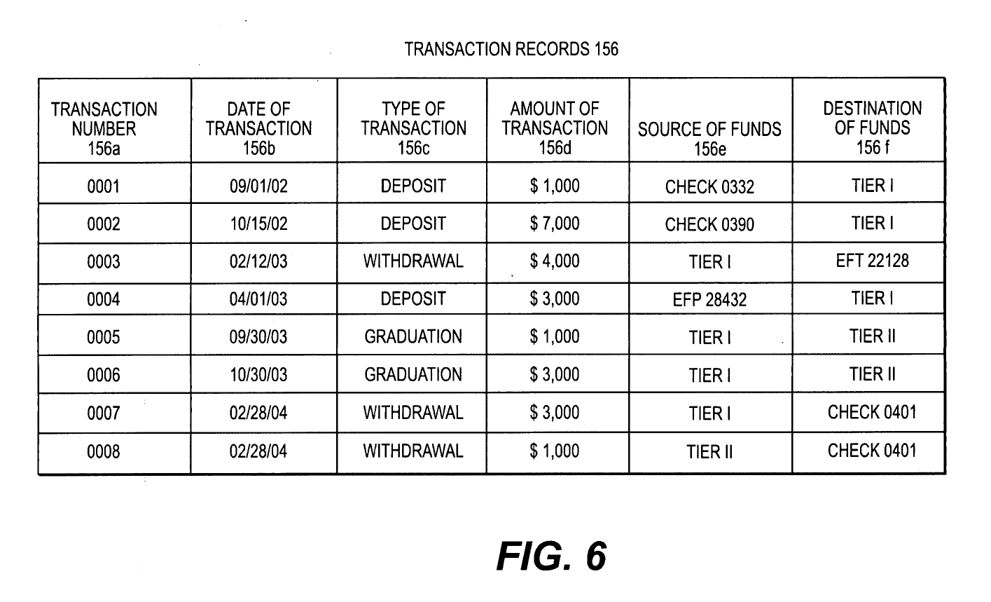

Specifically, FIG. 4 is a graph that shows a sample account history for the first two years of a tenure account structured according to Example 2, above; FIG. 5 is a table that depicts sample tier records 158 for the month of February, 2004, using data from the sample account history of FIG. 4; and FIG. 6 is a table that depicts a sample transaction records for the sample account history of FIG. 4.

As shown in FIG. 4, the sample tenure account is opened in September 2002. The closing balance (y-axis) in each of Tiers I and II is shown for each month (x-axis) through August 2004. No data is shown for Tiers III and IV because the balances for each of these tiers is zero over the period shown in FIG. 4. For simplicity, the data in FIGS. 4-6 do not reflect the interest earned during the period depicted.

Deposit Cycle 310

FIG. 3A is a flowchart that illustrates an exemplary deposit cycle 310. System 100 may enter a deposit cycle 310, e.g., when an account holder or other authorized entity makes a deposit to the tenure account.

Funds may be deposited to the tenure account by a variety of methods. For example, the account holder may deposit a check to the tenure account, e.g., by mail to the financial institution. The deposit cycle 310 may then be initiated, for example, when an employee of the financial institution enters the check into system 100, e.g., using input device 122. Alternatively, the account holder may deposit cash to the tenure account, e.g., via an ATM. As another example, the account holder may transfer funds from another financial account into the tenure account through an electronic funds transfer, e.g., via an ATM, the Internet or other network. The deposit cycle 310 may then be initiated, for example, when system 100 is notified of the electronic transaction by the outside network, e.g., via input interface 126.

Alternatively, the financial institution may itself deposit funds into the tenure account in accordance with tenure account rules 154. For example, tenure account rules 154 may indicate that the financial institution is to deposit interest distributions into the tenure account.

At 310a, system 100 may receive one or more attributes of the deposit. In one embodiment of the present invention, the attributes may include the date of the deposit and the amount of the deposit. However, other attributes of the deposit may also be received. For example, the source of the deposit, e.g., cash, check (e.g., by check number), electronic funds transfer, interest distribution, etc., may also be received. The attributes may be received through, e.g., input device 122, storage device 124, or input interface 126. For example, an employee of the financial institution may enter the attributes of the deposit using input device 122. Alternatively, the attributes may be received from an ATM, the Internet or other network linked to computing platform 110 through input interface 126.

At 310b, system 100 may determine the appropriate tier in which to place the deposit. System 100 may determine the appropriate tier from tenure account rules 154. As in Example 1, for instance, tenure account rules 154 may indicate that all customer deposits are to be placed in a particular tier (Tier I), while all interest distributions are to be placed in the Interest Tier.

Alternatively, tenure account rules 154 may indicate that deposits are to be placed in a particular tier or tiers based on a particular attribute or combination of attributes of the deposit. For example, tenure account rules 154 may be structured to encourage larger deposits by specifying that deposits that are greater than a certain amount, e.g., $9,999.99, are to be placed in a tier bearing a higher interest rate, e.g., Tier II.

At 310c, system 100 may place the deposit in the appropriate tier. For example, system 100 may credit the appropriate funds to the tenure account and update tier records 158 to reflect the added deposit.

FIG. 5 is a table illustrating exemplary data recorded in tier records 158. The data shown in FIG. 5 depicts sample tier records 158 for the month of February 2004 in the sample account history of FIG. 4. As shown in FIG. 5, each tier may be assigned a tier identifier 158a, such as a number or other index, that may be used to reference the particular tier. Tier records 158 may record, e.g., the current balance 158b of funds in each tier, the balance for the previous period 158c, the minimum balance over the tenure period 158d, and the interest rate or formula 158e. However, other data may also be recorded in tier records 158. For example, tier records 158 may further record the total balance 158f of funds within the tenure account. Thus, when a deposit is credited to the account, system 100 may update the current balance 158b of the appropriate tier and the total account balance 158f to add the deposited funds.

At 310d, system 100 may record one or more of the attributes of the deposit in transaction records 156. FIG. 6 is a table illustrating exemplary data recorded in transaction records 156 for the sample account history of FIG. 4. Although FIG. 6 illustrates transaction records 156 as recording the attributes for multiple types of transactions (e.g., deposit, withdrawal, graduation, etc.), the attributes of different types of transactions may instead be recorded in separate transaction records.

As shown in FIG. 6, system 100 may assign each deposit a transaction number 156a, such as a serial number or other index, that may be used to associate the recorded attributes with the particular transaction. Transaction records 156 may record, e.g., the date of the deposit 156b, the type of transaction 156c (e.g., deposit, withdrawal, graduation, fee, etc.), the amount of the deposit 156d, the source of the funds 156e (e.g., by check number, etc.) and their destination 156f (e.g., Tier I). For instance, as illustrated in FIG. 6, the amount of $1,000 was deposited to Tier I on Sep. 1, 2002, and assigned transaction number “0001.” However, other attributes of the deposit may also be recorded in transaction records 156.

After recording the attributes of the deposit, system 100 may return to 200 to wait for the occurrence of the next tenure account event. Processing may then continue as in FIG. 2.

Graduation Cycle 320

FIG. 3B is a flowchart that illustrates an exemplary graduation cycle 320. System 100 may initiate a graduation cycle 320, e.g., periodically. The length of time between graduation cycles 320 may be specified by tenure account rules 154. As in Examples 1 and 2 above, for instance, the graduation cycle may be performed monthly. However, tenure account rules 154 may indicate that graduation cycle 320 is to be initiated after some other period, e.g., quarterly, yearly, etc.

As in Examples 1 and 2 above, the period between graduation cycles 320 may be the same for all tiers in the tenure account. Alternatively, tenure account rules 154 may specify different periods for one or more tiers. Further, the tenure period for a particular tier may vary based upon one or more attributes of the tier or of the tenure account. For example, the tenure period for a particular tier may become shorter as the current tier balance 158b increases, or the account balance 158f increases. As another example, the tenure period for a particular tier may change according to the date, e.g., where the financial institution offers a shorter introductory tenure period in order to attract customers.

At 320a, system 100 may retrieve the rules relevant to the graduation of funds into a particular destination tier from tenure account rules 154. For example, system 100 may retrieve the number(s) of the source tier(s) from which funds may graduate into the particular destination tier (e.g., the next lower tier, as in Examples 1 and 2), and the tenure period that the funds must spend in the source tier in order to graduate into the destination tier (e.g., one year, as in Examples 1 and 2). In the first iteration of graduation cycle 320, system 100 may start with, e.g., the highest destination tier that is scheduled for a graduation cycle.

System 100 may also retrieve one or more additional conditions for graduation of funds from the source tier to the destination tier. The conditions may be of a variety of types. For example, tenure account rules 154 may indicate that funds may not graduate unless, e.g., the tenure account has a total balance greater than $9,999.99, or the customer has made deposits totaling $1000.00 over the last six months. As another example, tenure account rules 154 may specify that funds deposited into Tier I graduate to Tier II if the graduating balance is less than $9,999.99, but to Tier III if the graduating balance is $10,000.00 or higher. In this manner, tenure account rules 154 may be used to encourage the customer to deposit greater amounts into the tenure account.

At 320b, system 100 may determine whether all of the conditions for graduation of funds from the source tier to the destination tier (if any such conditions are specified) are met. To make this determination, system 100 may compare the relevant attribute or attributes retrieved at 320b with the graduation condition or conditions set forth in tenure account rules 154. For example, if tenure account rules 154 condition graduation upon the customer having a minimum tenure account balance 158f or tier balance 158b, system 100 may compare the relevant balance retrieved at 320b with the minimum balance specified by tenure account rules 154.

If system 100 determines that one or more conditions for graduation are not met (320b: No), then system 100 may cease processing the current destination tier and proceed to process the next destination tier, if any, at 320e. For example, system 100 may process the next highest destination tier that is scheduled for a graduation cycle.

If system 100 determines that all of the conditions for graduation are met (320b: Yes), then system 100 may determine the amount of funds in the source tier that meet the tenure requirement for graduation to the destination tier (320c), i.e., the tenured balance.

As in Example 1, for instance, tenure account rules 154 may specify that the monthly minimum balance for each tier will be used to determine the tenured balance. Alternatively, tenure account rules 154 may specify that the monthly closing balance for each tier will be used to determine the tenured balance. Further, tenure account rules 154 may specify another method for determining the amount of funds that meet the tenure requirement. For example, tenure account rules 154 may specify that, e.g., the average monthly balance is considered to have remained deposited for that month.

System 100 may use tier records 158 to record the tenured balance 158d for each tier. For example, system 100 may record the balance used to determine whether funds have remained in the account over the tenure period (e.g., monthly minimum, monthly closing, average monthly, etc., depending upon tender account rules 154). System 100 may update tenured balance 158d periodically (e.g., monthly, as in Examples 1 and 2) on a rolling basis. However, other methods of accounting for the tenured balance will be apparent to those of ordinary skill in the art.

At 320d, system 100 may graduate the amount of funds determined at 320c from the source tier to the destination tier. For example, system 100 may update tier records 158 to reflect the graduation of the tenured balance 158d from the source tier to the destination tier, e.g., by subtracting the tenured funds from the current balance 158b of the source tier and adding them to the current balance of the destination tier.

System 100 may also record one or more of the attributes of the graduation in a transaction records 156. As shown in FIG. 6, for example, system 100 may assign each graduation a transaction number 156a, and transaction records 156 may record the date of the graduation 156b, the amount graduated, the source of the funds 156e (e.g., Tier I) and their destination 156f (e.g., Tier II). For instance, as illustrated in FIG. 6, the amount of $1,000 was graduated from Tier I to Tier II on Sep. 30, 2003 (transaction number “0005”).

After graduating the tenured funds, system 100 may determine if there are any remaining destination tiers to be processed (320e). If so (320e: Yes), then system 100 may return to 320a to retrieve the relevant rules and/or conditions for graduation to the next destination tier. After all of the destination tiers have been processed (320e: No), then system 100 may return to 200 (see FIG. 2) to wait for the occurrence of the next tenure account event.

Interest Cycle 330

FIG. 3C is a flowchart that illustrates an exemplary interest cycle 330. System 100 may enter interest cycle 330, e.g., periodically. The length of time between interest cycles 330 may be specified by tenure account rules 154. For example, if the interest is to be compounded, then the period between interest cycles 330 may correspond to the period over which the interest is to be compounded. For example, the interest may be compounded daily, monthly, quarterly, yearly, etc. Alternatively, tenure account rules 154 may indicate that interest cycle 330 is to be initiated upon the occurrence of a certain event or combination of events. For example, tenure account rules 154 may indicate that interest cycle 330 is to be initiated whenever a statement cycle 350 is initiated.

The period between interest cycles 330 may be the same for all tiers in the tenure account. Alternatively, tenure account rules 154 may specify different periods for one or more tiers, e.g., where the interest for different tiers is compounded at different intervals. For example, tenure account rules 154 may indicate that the interest for one tier is to be compounded at one interval (e.g., daily), while the interest on another tier is to be compounded at some other interval (e.g., monthly).

At 330a, system 100 may retrieve the tier balance 158b from tier records 158 and retrieve the interest rate or formula 158e corresponding to the particular tier from tenure account rules 154. If the interest is given by a formula, then system 100 may also retrieve one or more parameters that are relevant to a determination of the interest rate. For example, the interest formula 158e for a particular tier may be based upon a changing index, e.g., the Treasury rate, or the financial institution's Money Market Account Base Rate (as in Examples 1 and 2). Consequently, system 100 may retrieve the current value of the index, e.g., by accessing an appropriate database via input interface 126.

Further, the interest formula 158e for a particular tier may vary based upon one or more attributes of the tier or of the tenure account. For example, the interest rate for a particular tier may increase as the current tier balance 158b increases, or the account balance 158f increases. As another example, the interest rate for a particular tier may change according to the date, e.g., where the financial institution offers a higher introductory interest rate in order to attract customers. After retrieving the appropriate parameters, system 100 may then calculate the interest rate.

At 330b, system 100 may calculate the interest for the tier. For example, system 100 may calculate the interest based on the tier balance 158b and the interest rate 158e retrieved or calculated at 330a.

At 330c, system 100 may distribute the interest calculated at 330b to the customer in accordance with tenure account rules 154. For instance, the calculated interest may be distributed to the customer by depositing it into the tenure account. For example, the interest from each tier may be distributed to a separate Interest Tier, as in Example 1 above. Alternatively, the interest from each tier may be distributed back (i.e., compounded) into that same tier, as in Example 2, or into a particular tier, e.g., Tier I. However, the distribution of interest is not limited to these methods. For example, tenure account rules 154 may indicate that the interest from a particular tier is to be distributed to the customer, e.g., as a monetary dividend or as reward points, such as frequent flyer miles.

System 100 may distribute the interest by updating transaction records 156 and/or tier records 158. For example, system 100 may update transaction records 156 by entering the attributes of the interest distribution.

Where the calculated interest is to be distributed into the tenure account, system 100 may initiate a deposit cycle 310 in which the interest distribution is deposited to the tenure account in accordance with tenure account rules 154. Where the calculated interest is to be distributed to the customer in some other manner, system 100 may initiate a withdrawal cycle 340 in which the interest that was deposited to the account is withdrawn. System 100 may then effect the withdrawal, e.g., by printing a check to the customer using printer 132 or by transferring funds or reward points to a designated account via output interface 134.

After distributing the interest for the particular tier, system 100 may determine if there are any remaining tiers to be processed (330d). If so (330d: Yes), then system 100 may return to 330a to retrieve the tier balance and interest rate or formula corresponding to the next tier. After all of the tiers in the tenure account have been processed (330d: No), system 100 may return to 200 (see FIG. 2) to wait for the occurrence of the next tenure account event.

Withdrawal Cycle 340

FIG. 3D is a flowchart that illustrates an exemplary withdrawal cycle 340. System 100 may enter a withdrawal cycle, e.g., when an account holder or other authorized entity makes a request to withdraw funds from the tenure account.

The account holder may withdraw funds from the tenure account by a variety of methods. For example, the account holder may draft a check on the tenure account. The withdrawal cycle 340 may then be initiated, for example, when an employee of the financial institution enters the check into system 100, e.g., using input device 122. Alternatively, the account holder may withdraw or transfer funds from the tenure account using an ATM, the Internet or other network linked to computing platform 110 through input interface 126. As another example, the account holder may transfer funds from the tenure account to another financial account through an electronic funds transfer, e.g., via an ATM, the Internet, or another network. The withdrawal cycle 340 may then be initiated, for example, when system 100 is notified of the electronic transaction by the outside network, e.g., via input interface 126.

Alternatively, the financial institution may withdraw funds from the tenure account in accordance with tenure account rules 154. For example, tenure account rules 154 may indicate that the financial institution may withdraw funds from the tenure account in order to pay penalties and/or fees associated with the tenure account, such as a fee for bouncing a check, etc.

At 340a, system 100 may receive one or more attributes of the withdrawal request. For example, system 100 may receive the amount of the withdrawal request. However, other attributes of the withdrawal request may also be received. System 100 may receive the attributes through, e.g., input device 122, storage device 124, or input interface 126. For example, an employee of the financial institution may enter the attributes of the withdrawal request using input device 122, or received from an ATM, the Internet or other network linked to computing platform 110 through input interface 126.

At 340b, system 100 may determine whether the tenure account has sufficient funds to meet the requested withdrawal. To make this determination, system 100 may compare the amount of the requested withdrawal received at 340a with the account balance 158f from tier records 158.

If system 100 determines that the tenure account does not contain sufficient funds to satisfy the requested withdrawal (340b: No), then system 100 may deny the requested withdrawal (340c). For example, in denying the withdrawal, system 100 may generate an “insufficient funds” message to the requesting customer, e.g., via output interface 134. System 100 may then cease processing the request, and instead return to 200 (see FIG. 2) to wait for the occurrence of the next tenure account event.

If system 100 determines that the tenure account contains sufficient funds to satisfy the requested withdrawal (340b: Yes), then system 100 may effect the withdrawal in accordance with tenure account rules 154.

As in Example 1, for instance, tenure account rules 154 may specify that withdrawals are to be effected by withdrawing the funds from a tier having terms that are less advantageous to the customer before being withdrawn from a tier having terms that are more advantageous to the customer. For example, tenure account rules 154 may specify that withdrawals are to be effected by withdrawing the funds from a tier earning a lower interest rate before being withdrawn from a tier earning a higher interest rate, as in Example 2.

However, tenure account rules 154 may specify that withdrawals are to be effected by withdrawing funds in another manner, consistent with the present invention. For example, tenure account rules 154 may specify that withdrawals are to be effected by withdrawing funds from a tier having terms that are more advantageous to the customer before being withdrawn from a tier having terms that are less advantageous to the customer. For instance, rather than specifying that withdrawals are to be effected by withdrawing funds from the Interest Tier first (as in Example 1), tenure account rules may specify that funds are to be withdrawn from Tier I first.

At 340d, system 100 may identify the tier from which funds are to be withdrawn first. For example, tenure account rules 154 may specify the order in which funds are to be withdrawn from the tiers of the tenure account. Alternatively, system 100 may identify the tier having the terms that are least advantageous to the customer, e.g., the tier that is currently earning the lowest interest rate. For example, system 100 may compare the interest rate or formula for each tier in order to determine which yields the lowest interest rate. In Example 2, for instance, system 100 may identify the Tier I as the tier earning the lowest interest rate.

At 340e, system 100 may withdraw funds from the tier identified at 340d. System may withdraw an amount of funds equal to the tier balance or to the amount of the withdrawal request, whichever is lower. System 100 may withdraw the funds, e.g., by subtracting the withdrawn funds from current tier balance 158b and total account balance 158f.

At 340f, system 100 may determine if the withdrawn funds satisfy the withdrawal request. If not, i.e., if the balance of the previously identified tier was less than the amount of the requested withdrawal (340f: No), then system 100 may return to 340d to identify the tier that is next in the withdrawal order, e.g., the tier earning the next lowest interest rate as in Example 2 above. System 100 may then withdraw funds from this tier, and so on, until the withdrawn funds equal the amount of the withdrawal request (340f: Yes).

For instance, as illustrated in FIG. 6, transaction numbers “0007” and “0008,” check number 0401 in the amount of $4,000 was drafted on the sample tenure account on Feb. 28, 2004. According to the rules for Example 2, the withdrawal was effected by first withdrawing funds from Tier I. However, because the balance for Tier I was only $3,000 at that time (see FIG. 4), system 100 must also withdraw $1,000 from Tier II (the next tier in the withdrawal order) in order to satisfy the check number.

Thus, system 100 may withdraw funds having the least advantageous terms (e.g., the tier earning the lowest interest rate) first, then funds having the next least advantageous terms (e.g., the tier earning the next lowest interest rate), and so on, until the withdrawal request is satisfied. In this manner, system 100 may encourage customers to leave their savings in the tenure account for longer periods.

After the withdrawal request is satisfied (340f: Yes), system 100 may disburse the withdrawn funds (340g). For example, system 100 may disburse the withdrawn funds, e.g., by printing a check to the customer using printer 132, or transferring the funds electronically to a designated account using output interface 134, or approving a cash withdrawal via an ATM network.

At 340h, system 100 may record one or more attributes of the withdrawal in transaction records 156. As shown in FIG. 6, the recorded withdrawal attributes may be similar to those recorded with respect to deposits. For example, system 100 may assign a transaction number 156a to the withdrawal, and record, e.g., the date 156b and the amount 156d of the transaction, the source of the funds 156e (e.g., Tier II), and the destination of the funds 156f (e.g., by check number). For instance, as illustrated in FIG. 6, on Feb. 28, 2004, the amount of $3,000 was withdrawn from Tier I and the amount of $1,000 was withdrawn from Tier II in order to satisfy check number 0401 (transaction numbers “0007” and “0008.” However, other attributes of the withdrawal may also be recorded in transaction records 156.

After recording the withdrawal attributes, system 100 may return to 200 (see FIG. 2) to wait for the occurrence of the next tenure account event. Processing may then continue as in FIG. 2.

Statement Cycle 350

FIG. 3E is a flowchart that illustrates an exemplary statement cycle 350. System 100 may enter statement cycle 350, e.g., periodically. The length of time between statement cycles 350 may be specified by tenure account rules 154. For example, tenure account rules may specify that statements are to be issued monthly, quarterly, yearly, etc. Alternatively, tenure account rules 154 may indicate that statement cycle 350 may be initiated upon the occurrence of a certain event or combination of events. For example, tenure account rules 154 may indicate that statement cycle 350 may be initiated at the request of the customer, e.g., via the Internet or another network linked to computing platform 110 via input interface 126, or at the request of a customer service representative, e.g., via input device 122.

At 350a, system 100 may retrieve relevant information concerning the account. For example system 100 may retrieve data from transaction records 156 and tier records 158 pertaining to the period to be covered by the statement, e.g., the period since the previous statement cycle.

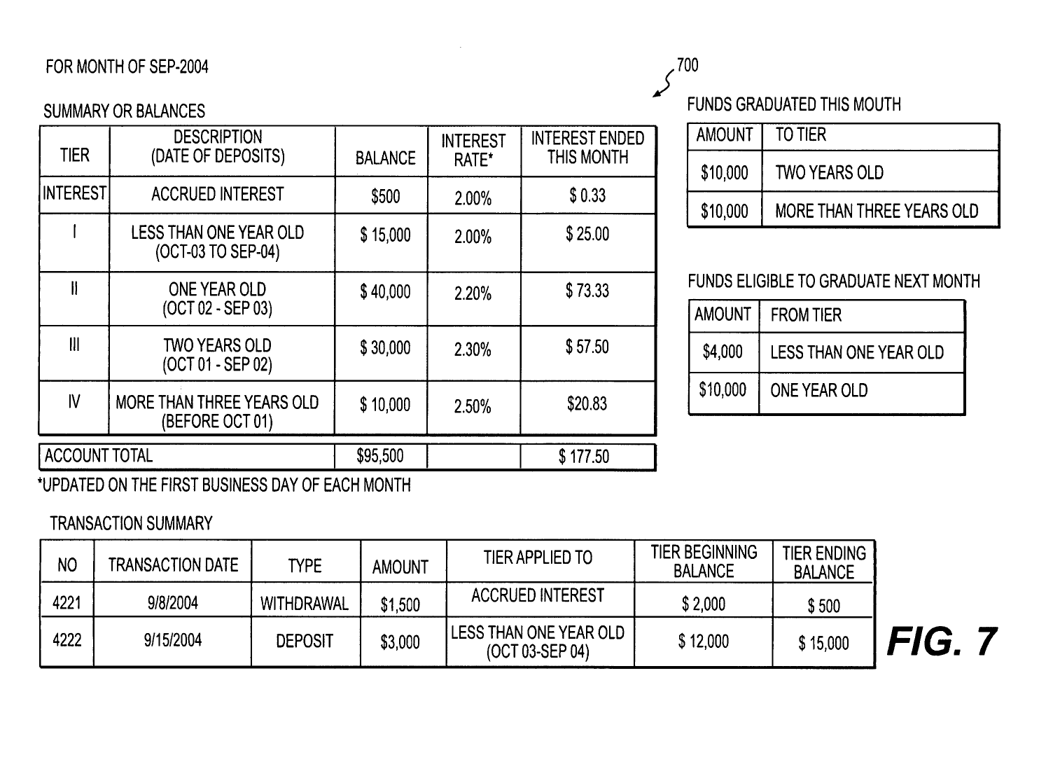

At 350b, system 100 may generate an account statement. FIG. 7 illustrates a sample account statement 700 that may be generated for a tenure account, consistent with the present invention. Note that the data shown in FIG. 7 is unrelated to the data shown in FIGS. 4-6.

As shown in FIG. 7, account statement 700 may present relevant data from transaction records 156 and tier records 158. Account statement 700 may also present information regarding the amount of funds that are eligible to graduate in the next period. By presenting this information, account statement 700 may provide an incentive for the customer to allow the funds to remain in the account in order to secure a higher interest rate upon graduation of the funds.

At 350c, system 100 may present the account statement. The account statement may be presented in a number of ways. For example, system 100 may print a statement, e.g., to be mailed to the customer, using printer 132. Alternatively, system 100 may generate a statement to be presented to the customer over an ATM network, the Internet, or other network linked to computing platform 110 via output interface 134. As a further alternative, system 100 may display the statement to, e.g., a customer service representative, via display 136.

After presenting the account statement, system 100 may return to 200 to wait for the occurrence of the next tenure account event. Processing may then continue as in FIG. 2.

Accordingly, by providing for the graduation of deposited funds to tiers having successively higher interest rates, systems and methods consistent with the present invention give customers a degree of control with respect to the interest rate on the account. Further, by removing the substantial penalty for early withdrawal common to prior art financial accounts, systems and methods consistent with the present invention remove a substantial disincentive for customers to invest in such accounts. Systems and methods consistent with the present invention thus encourage customers to open accounts with financial institutions and to invest more funds in such accounts for longer periods.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for managing a financial account, comprising:
creating, within the financial account, a plurality of tiers for holding funds, the plurality of tiers comprising at least a first tier and a second tier;
subjecting funds held in the second tier to more favorable terms than funds held in the first tier; and
using a computer:
determining an amount of tenured funds consisting of funds that have remained in the first tier for a first tenure period; and
graduating the tenured funds from the first tier to the second tier.

2. The method of claim 1, wherein subjecting funds held in the second tier to more favorable terms comprises paying a higher interest rate on funds held in the second tier than on funds held in the first tier.

3. The method of claim 2, wherein paying a higher interest rate comprises setting an interest rate for the second tier that is higher than the interest rate for the first tier by one of a predetermined percentage, a predetermined value, or a predetermined formula.

4. The method of claim 1, wherein determining the amount of tenured funds and graduating the tenured funds are performed periodically.

5. The method of claim 1, wherein the plurality of tiers comprise a third tier and the method further comprises:
subjecting funds held in the third tier to more favorable terms than funds held in either the first tier or the second tier; and
using a computer:
determining an amount of tenured funds consisting of funds that have remained in the second tier for a second tenure period; and
graduating the tenured funds from the second tier to the third tier.

6. The method of claim 5, wherein the second tenure period is the same length as the first tenure period.

7. The method of claim 1, further comprising:
paying interest on funds held in at least one of the plurality of tiers; and
distributing the interest on funds held in each respective tier to one of the same tier or a different tier.

8. The method of claim 7, wherein the interest is distributed to a different tier, and the different tier is subject to different terms than at least one of the other tiers of the plurality of tiers.

9. The method of claim 1, further comprising:
receiving a request to withdraw funds from the account; and
using a computer:
satisfying the request by withdrawing funds from the first tier before withdrawing funds from the second tier.

10. The method of claim 9, wherein the plurality of tiers further comprises a third tier and the method further comprises:
subjecting funds held in the third tier to more favorable terms than funds held in either the first tier or the second tier; and
satisfying the request further comprises:
withdrawing funds from the second tier before withdrawing funds from the third tier.

11. A method for managing a financial account, comprising:
creating, within the financial account, a plurality of tiers for holding funds, the plurality of tiers comprising at least a first tier and a second tier;
subjecting funds held in the second tier to more favorable terms than funds held in the first tier;
receiving a request to withdraw funds from the account; and
using a computer:
satisfying the request by withdrawing funds from the first tier before withdrawing funds from the second tier.

12. The method of claim 11, wherein subjecting funds held in the second tier to more favorable terms comprises paying a higher interest rate on funds held in the second tier than on funds held in the first tier.

13. The method of claim 12, wherein paying a higher interest rate comprises setting an interest rate for the second tier that is higher than the interest rate for the first tier by one of a predetermined percentage, a predetermined value, or a predetermined formula.

14. The method of claim 11, wherein the plurality of tiers comprises a third tier and the method further comprises:
subjecting funds held in the third tier to more favorable terms than funds held in either the first tier or the second tier; and
satisfying the request further comprises:
withdrawing funds from the second tier before withdrawing funds from the third tier.

15. A computer-readable medium containing instructions capable of configuring a computing platform to perform a method for managing a financial account, the method comprising:
creating, within the financial account, a plurality of tiers for holding funds, the plurality of tiers comprising at least a first tier and a second tier;
subjecting funds held in the second tier to more favorable terms than funds held in the first tier; and
using a computer:
determining an amount of tenured funds consisting of funds that have remained in the first tier for a first tenure period; and
graduating the tenured funds from the first tier to the second tier.

16. The computer-readable medium of claim 15, wherein subjecting funds held in the second tier to more favorable terms comprises paying a higher interest rate on funds held in the second tier than on funds held in the first tier.

17. The computer-readable medium of claim 16, wherein paying a higher interest rate comprises setting an interest rate for the second tier that is higher than the interest rate for the first tier by one of a predetermined percentage, a predetermined value, or a predetermined formula.

18. The computer-readable medium of claim 15, wherein determining the amount of tenured funds and graduating the tenured funds are performed periodically.

19. The computer-readable medium of claim 15, wherein the plurality of tiers further comprises a third tier and the method further comprises:
subjecting funds held in the third tier to more favorable terms than funds held in either the first tier or the second tier; and
using a computer:
determining an amount of tenured funds consisting of funds that have remained in the second tier for a second tenure period; and
graduating the tenured funds from the second tier to the third tier.

20. The computer-readable medium of claim 19, wherein the second tenure period is the same length as the first tenure period.

21. The computer-readable medium of claim 15, further comprising:
paying interest on funds held in at least one of the plurality of tiers; and
distributing the interest on funds held in each respective tier to one of the same tier or a different tier.

22. The computer-readable medium of claim 21, wherein the interest is distributed to a different tier, and the different tier is subject to different terms than at least one of the other tiers of the plurality of tiers.

23. The computer-readable medium of claim 15, further comprising:
receiving a request to withdraw funds from the account; and
using a computer:
satisfying the request by withdrawing funds from the first tier before withdrawing funds from the second tier.

24. The computer-readable medium of claim 23, wherein the plurality of tiers further comprises a third tier and the method further comprises:
subjecting funds held in the third tier to more favorable terms than funds held in either the first tier or the second tier; and
satisfying the request further comprises:
withdrawing funds from the second tier before withdrawing funds from the third tier.

25. A computer-readable medium for managing a financial account,
comprising:
creating, within the financial account, a plurality of tiers for holding funds, the plurality of tiers comprising at least a first tier and a second tier;
subjecting funds held in the second tier to more favorable terms than funds held in the first tier;
receiving a request to withdraw funds from the account; and
using a computer:
satisfying the request by withdrawing funds from the first tier before withdrawing funds from the second tier.

26. The computer-readable medium of claim 25, wherein subjecting funds held in the second tier to more favorable terms comprises paying a higher interest rate on funds held in the second tier than on funds held in the first tier.

27. The computer-readable medium of claim 26, wherein paying a higher interest rate comprises setting an interest rate for the second tier that is higher than the interest rate for the first tier by one of a predetermined percentage, a predetermined value, or a predetermined formula.

28. The computer-readable medium of claim 25, wherein the plurality of tiers further comprises a third tier and the method further comprises:
subjecting funds held in the third tier to more favorable terms than funds held in the either the first tier or the second tier; and
satisfying the request further comprises:
withdrawing funds from the second tier before withdrawing funds from the third tier.

29. A system for managing a financial account, comprising:
means for creating, within the financial account, a plurality of tiers for holding funds, the plurality of tiers comprising at least a first tier and a second tier;
means for subjecting funds held in the second tier to more favorable terms than funds held in the first tier;
means for determining an amount of tenured funds consisting of funds that have remained in the first tier for a first tenure period; and
means for graduating the tenured funds from the first tier to the second tier.

30. The system of claim 29, wherein the means for subjecting funds held in the second tier to more favorable terms comprises means for paying a higher interest rate on funds held in the second tier than on funds held in the first tier.

31. The system of claim 30, wherein the means for paying a higher interest rate comprises means for setting an interest rate for the second tier that is higher than the interest rate for the first tier by one of a predetermined percentage, a predetermined value, or a predetermined formula.

32. The system of claim 29, wherein the means for determining the amount of tenured funds and the means for graduating the tenured funds perform their functions periodically.

33. The system of claim 29, wherein the plurality of tiers further comprises a third tier and the system further comprises:
means for subjecting funds held in the third tier to more favorable terms than funds held in either the first tier or the second tier;
means for determining an amount of tenured funds consisting of funds that have remained in the second tier for a second tenure period; and
means for graduating the tenured funds from the second tier to the third tier.

34. The system of claim 33, wherein the second tenure period is the same length as the first tenure period.

35. The system of claim 29, further comprising:
means for paying interest on funds held in at least one of the plurality of tiers; and
means for distributing the interest on funds held in each respective tier to one of the same tier or a different tier.

36. The system of claim 35, wherein the interest is distributed to a different tier, and the different tier is subject to different terms than at least one of the other tiers of the plurality of tiers.

37. The system of claim 29, further comprising:
means for receiving a request to withdraw funds from the account; and
means for satisfying the request by withdrawing funds from the first tier before withdrawing funds from the second tier.

38. The system of claim 37, wherein the plurality of tiers further comprises a third tier and the system further comprises:
means for subjecting funds held in the third tier to more favorable terms than funds held in the either the first tier or the second tier; and
the means for satisfying the request further comprises:
means for withdrawing funds from the second tier before withdrawing funds from the third tier.

39. A system for managing a financial account, comprising:
means for creating, within the financial account, a plurality of tiers, the plurality of tiers comprising at least a first tier and a second tier;
means for subjecting funds held in the second tier to more favorable terms than funds held in the first tier;
means for receiving a request to withdraw funds from the account; and
means for satisfying the request by withdrawing funds from the first tier before withdrawing funds from the second tier.

40. The system of claim 39, wherein the means for subjecting funds held in the second tier to more favorable terms comprises means for paying a higher interest rate on funds held in the second tier than on funds held in the first tier.

41. The system of claim 40, wherein the means for paying a higher interest rate comprises means for setting an interest rate for the second tier that is higher than the interest rate for the first tier by one of a predetermined percentage, a predetermined value, or a predetermined formula.

42. The system of claim 39, wherein the plurality of tiers further comprises a third tier and the system further comprises:
means for subjecting funds held in the third tier to more favorable terms than funds held in either the first tier or the second tier; and
the means for satisfying the request further comprises:
means for withdrawing funds from the second tier before withdrawing funds from the third tier.
